(19) United States
(12) Patent Application Publication
(10) Pub. No.: US 2007/0053428 A1
(43) Pub. Date: Mar. 8, 2007

(54) MANAGED DEGRADATION OF A VIDEO STREAM

(75) Inventors: Shahid Saleem, Toronto, ON (CA); Indra Laksono, Richmond Hill, ON (CA); Suiwu Dong, Markham, ON (CA)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: VIXS Systems, Inc., Toronto, ON (CA)

(21) Appl. No.: 11/553,210

(22) Filed: Oct. 26, 2006

Related U.S. Application Data
(63) Continuation-in-part of application No. 11/344,512, filed on Jan. 31, 2006.
Application No. 11/344,512 is a continuation of application No. 09/823,646, filed on Mar. 30, 2001.

(51) Int. Cl. H04B 1/66

(52) U.S. Cl. 375/240

(57) ABSTRACT

A system and a method for simultaneous transmission of multiple media streams in a fixed bandwidth network are disclosed herein. The system is comprised of a central gateway media server and a plurality of client receiver units. The input media streams arrive from an external source and are then transmitted to the client receiver units in a compressed format. A state machine on the gateway media server detects if the network bandwidth is close to saturation. In one embodiment, the potential bandwidth saturation is measured by matching the time when the start of unit of media for each stream against the estimated transmission time for that unit. When any one actual transmission time exceeds its estimated transmission time by a predetermined threshold value, the network is deemed to be close to saturation, or already saturated, and the state machine executes a process of selecting at least one stream as a target for lowering total bandwidth usage. Once the target stream associated with a client receiver unit is chosen, the amount of data transmitted by the target stream is reduced, which could result in a lower data transmission rate. In one embodiment, the amount of data is reduced by a gradual degradation of the precision of the data, resulting in a greater potential for data compression, and/or by gradually reducing the resolution of the data of the target stream.

### PRIORITY INFORMATION

This application is a continuation-in-part of U.S. patent application having application Ser. No. 11/344,512, filed on Jan. 31, 2006 (Attorney Docket Number 1459-VIXS002C), which is a continuation of application Ser. No. 09/823,646, filed on Mar. 30, 2001(Attorney Docket Number 1459-VIXS002). U.S. patent applications having application Ser. No. 11/344,512 and application Ser. No. 09/823,646 are hereby incorporated in their entirety by reference.

### FIELD OF THE DISCLOSURE

The present invention relates generally to media data transmission and more particularly to reducing bandwidth overload.

### BACKGROUND

A number of media playback systems use continuous media streams, such as video image streams, to output media content. However, some continuous media streams in their raw form often require high transmission rates, or bandwidth, for effective and/or timely transmission. In many cases, the cost and/or effort of providing the required transmission rate is prohibitive. This transmission rate problem is often solved by compression schemes that take advantage of the continuity in content to create highly packed data. Compression methods such Motion Picture Experts Group (MPEG) methods and its variants for video are well known in the art. MPEG and similar variants use motion estimation of blocks of images between frames to perform this compression. With extremely high resolutions, such as the resolution of 1920×1080i used in high definition television (HDTV), the data transmission rate of such a video image stream will be very high even after compression.

One problem posed by such a high data transmission rate is data storage. Recording or saving high resolution video image streams for any reasonable length of time requires considerably large amounts of storage that can be prohibitively expensive. Another problem presented by a high data transmission rate is that many output devices are incapable of handling the transmission. For example, display systems that can be used to view video image streams having a lower resolution may not be capable of displaying such a high resolution. Yet another problem is the limitations on continuous media streaming in systems with a fixed bandwidth or capacity. For example, in a local area network with multiple receiving/output devices such a network will often have a fixed bandwidth or capacity, and hence be physically and/or logistically incapable of simultaneously supporting multiple receiving/output devices.

Given the limitations, as discussed, it is apparent that a method and/or system that overcomes at least some of these limitations would be advantageous.

### BRIEF DESCRIPTION OF THE DRAWINGS

FIG. 1 is a flow diagram illustrating a method in accordance with the present disclosure;

FIG. 2 is a graph illustrating a data reduction applied by various data reduction techniques as a portion of a total desired data reduction.

FIG. 3 is a state machine diagram illustrating an Adaptive Bandwidth Footprint Matching implementation according to at least one embodiment of the present invention;

FIG. 4 is a system diagram illustrating a server system for implementing Adaptive Bandwidth Footprint Matching according to at least one embodiment of the present invention;

FIG. 5 is a block diagram illustrating components of a gateway media server according to at least one embodiment of the present invention;

FIG. 6 is a block diagram illustrating components of a receiver client unit according to at least one embodiment of the present invention; and

FIG. 7 is a block diagram of a system in accordance with the present invention.

FIGS. 8 and 9 are flow diagrams of specific embodiments of the present disclosure.

### DETAILED DESCRIPTION OF THE FIGURES

In accordance with at least one embodiment of the present invention, a display data is received. It is determined if a predetermined criteria is met by a first representation of the display data, wherein the first representation of the display data includes a first plurality of display streams to be transmitted to a second plurality of display devices. A first display stream of the first plurality of display streams is compressed in a first manner when it is determined that the first representation of the display does not meet the predetermined criteria. An advantage of the present invention is that networks for broadcasting of media streams are implemented more efficiently. Another advantage of the present invention is that multiple media streams may be transmitted to multiple users on a fixed bandwidth network by managing degradation in transmission quality.

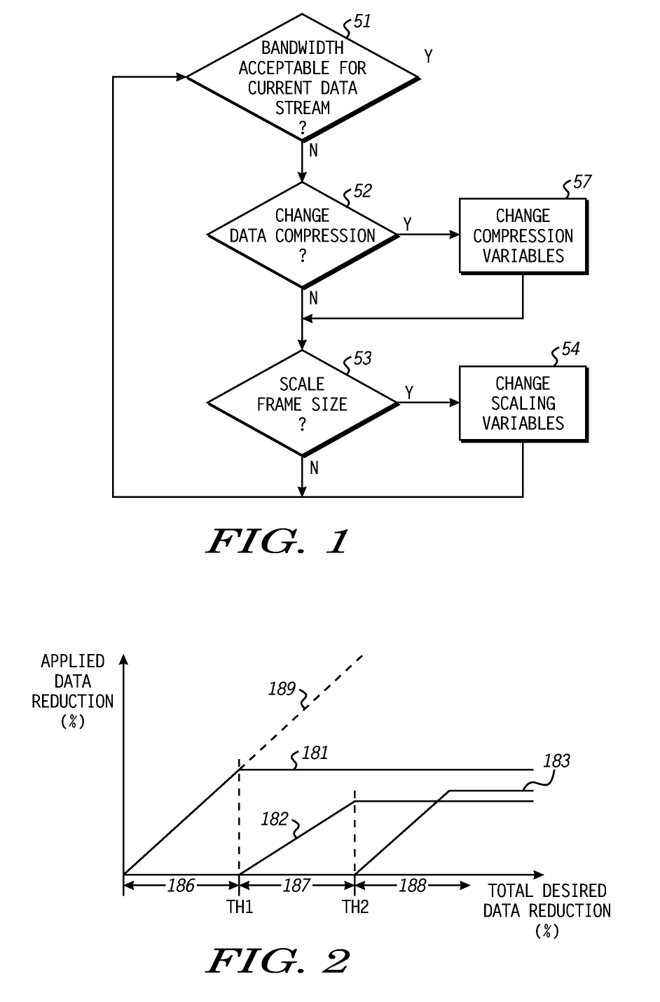

FIGS. 1-9 illustrate a system and a method for transmission of multiple data streams in a bandwidth-limited network. The system includes a central gateway media server and a plurality of client receiver units. The input data streams arrive from an external source, such as a satellite television transmission, or physical head end, and are transmitted to the client receiver units in a compressed format. The data streams can include display data, graphics data, digital data, analog data, multimedia data, and the like. An Adaptive Bandwidth Footprint Matching state machine on the gateway media server detects if the network bandwidth is close to saturation. The start time of each unit of media for each stream is matched against the estimated transmission time for that unit. When any one actual transmission time exceeds its estimated transmission time by a predetermined threshold, the network is deemed to be close to saturation, or already saturated, and the state machine will execute a process of selecting at least one stream as a target for lowering total bandwidth usage. Once the target stream associated with a client receiver unit is chosen, the target stream is modified to transmit less data, which may result in a lower data transmission rate. For example, a decrease in the data to be transmitted can be accomplished by a gradual escalation of the degree of data compression performed on the target stream, thereby reducing the resolution of the target stream. If escalation of the degree of data compression alone does not adequately reduce the data to be transmitted to prevent bandwidth saturation, the resolution of the target stream can also be reduced. For example, if the target stream is a video stream, the frame size could be scaled down, reducing the amount of data per frame, and thereby reducing the data transmission rate. It will be appreciated that the data reduction techniques described are applied to display data streams independently and can be applied when only a single display data stream is being transmitted to reduce the amount of data transmitted for that display data stream.

Referring to FIG. 1, a method of changing the amount of data being transmitted by at least one display stream based upon an available bandwidth is illustrated. The method of FIG. 1 begins at block 51, where a level of data reduction to be applied to a video stream is monitored as part of deciding whether the available bandwidth over a transmission medium is acceptable for a display data stream based on current encoding. It will be appreciated that a bandwidth available for transmission of a display data stream is not acceptable when the amount of data needed to represent the display data stream, based on a current set of compression and scaling parameters, comes close to saturating the bandwidth, i.e. using all of the available bandwidth because a reduction in the available bandwidth, or an increase in the amount of data needed to represent the display data stream, can result in a loss of display data stream information. Similarly, a bandwidth can be considered not acceptable for a display data stream when the amount of data used to represent the display data stream, based on the current set of compression and scaling parameters, is not close to saturating the available bandwidth, thereby indicating that less aggressive compression and scaling can be used to represent a higher quality display data stream.

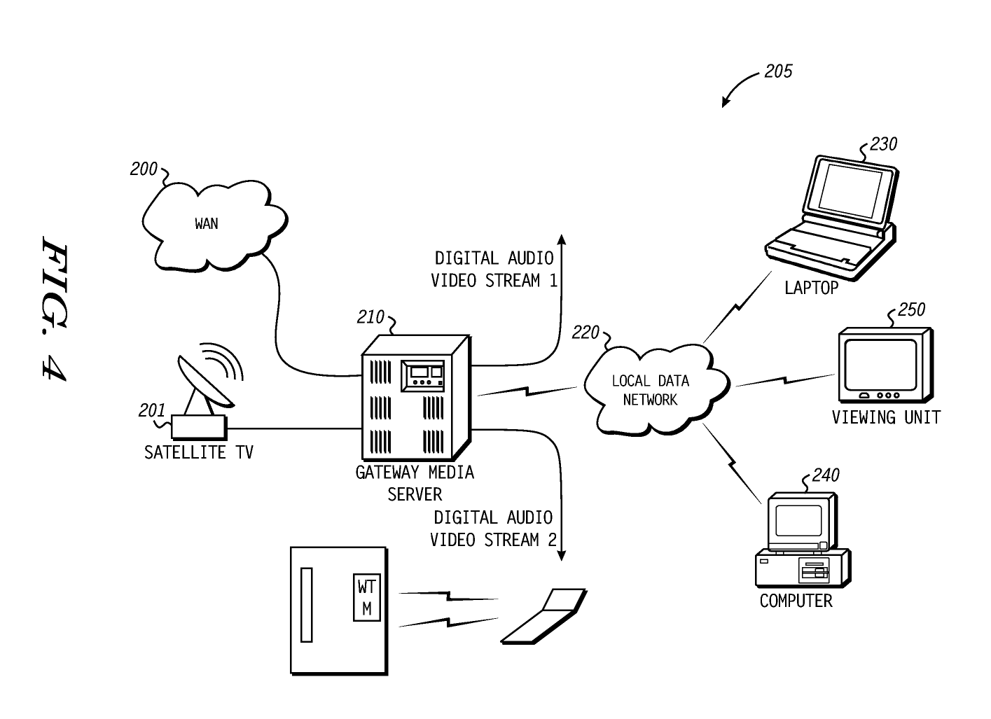

It will be appreciated that a channel's bandwidth can become unacceptable for transmission of a display data stream because the bandwidth of the channel changes, or because a portion of the channel's bandwidth that is available to transmit the display data stream changes, and because the amount of data to be transmitted changes. For example, even when a display data stream is allocated the entire bandwidth of a communications channel, such as a wireless network (e.g. an 802.11 compliant network), changes in bandwidth of the communication channel will affect the amount display data that can be transmitted. Similarly, when a display data stream is allocated a portion of a given network's bandwidth, a change in the portion allocated to the data stream will affect the amount of display data that can be transmitted. Information relating to such changes in the available bandwidth can be obtained from a transmission module, which can included the controller 395 described herein, that empirically or deterministically monitors the available bandwidth, such as through the use of adaptive bandwidth footprint matching as described herein at states 100 and 110 of FIG. 3. Changes in available bandwidth can be determined by comparing the current available bandwidth to a previous available bandwidth. In one embodiment, an indication that a change in available bandwidth meets a threshold by generating an interrupt. Alternatively, a control module associated with an encoder can access current bandwidth information to determine when changes occur in available bandwidth.

It will be further appreciated that the amount of data needed to represent a display data stream can vary depending upon the specific display information being transmitted. An encoding device can monitor changes in the amount of data needed to represent a specific portion of the display data stream.

The method of FIG. 1 proceeds from block 51 to block 55 when it is determined that the bandwidth is acceptable for a current display data stream, otherwise flow proceeds to block 52.

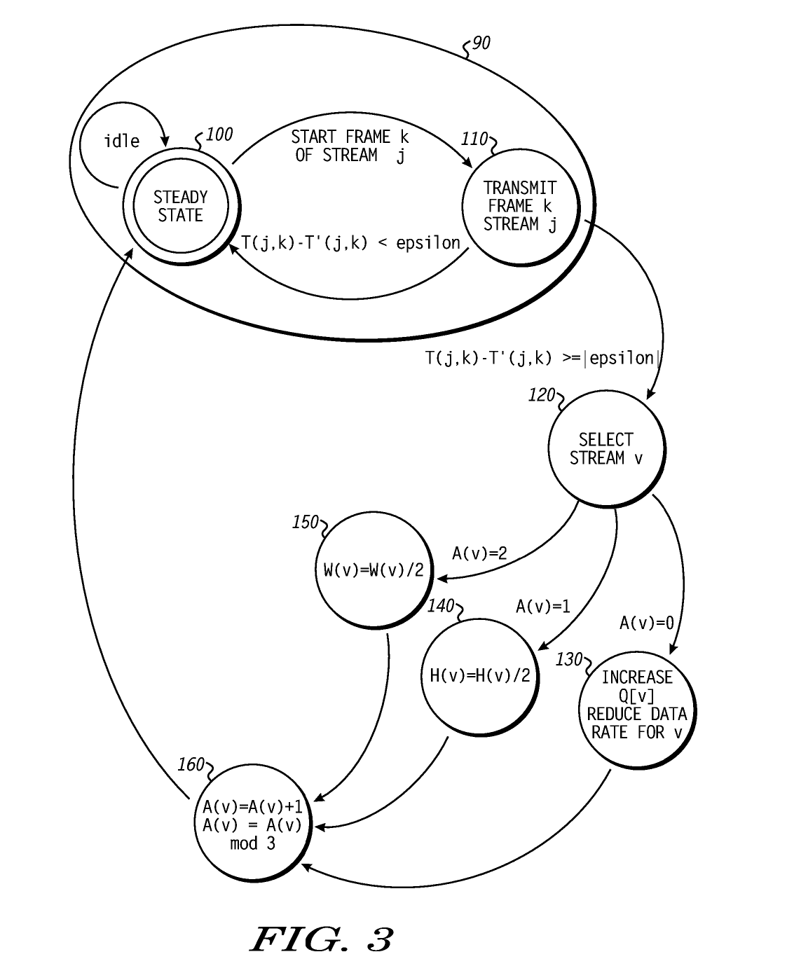

At block 52, a determination is made whether a change in the amount of data compression of the display data stream should occur. For example, in one embodiment, if the amount of data reduction to a target display data stream that is needed is less than a specific threshold it will be determined that further data reduction through the use of compression techniques, such as the use of larger quantization factors, is appropriate. For example, data reduction techniques using compression, such as quantization, as described at state 130 of FIG. 3, can be used to compress a display stream a defined amount without experiencing detrimental visual artifacts, such as blocking. Therefore, additional or less data compression, as represented by line 81 of FIG. 2, is acceptable to increase or reduce the amount of data used represent the display stream as long as the amount of data reduction does not exceed a blocking threshold, typically from 30%-50%, such as TH1 illustrated in FIG. 2.

However, once the amount of data reduction sought is greater than a threshold that indicates further data reduction would likely trigger blocking or other visual artifacts, then an alternate data reduction technique is used. It will be appreciated that other data compression techniques besides quantization can be used, such as reducing an available color depth of each pixel. Note that the threshold values can be predetermined values set based on user preference.

Once it is determined at block 52 that the level of compression to be applied to a display data stream is to change, flow proceeds to block 57 where a compression variable, such as a set of quantization levels, is provided to an encoder to set a level of compression to be applied to the target display data stream. The compression level is increased to reduce the bandwidth used to transmit a representation of the display data, and the compression level is decreased to increase the bandwidth used to transmit a representation of the display data when there is sufficient available bandwidth to support providing more data to represent a higher quality representation of the data stream. As illustrated in FIG. 2, the amount of data reduction to a data stream attributable to compression variables set at block 57 is represented by line 181, which indicates that the amount of compression is variable when the total desired compression (X-axis) is between 0% and a threshold TH1. Beyond the threshold TH1 the amount of compression performed by compression is constant, indicating that the compression variables do not change. Note that line 189 represents a total amount of data reduction that is the sum of the various amounts of data reduction affected by lines 181-183, and is coincident with line 181 below threshold TH1.

At block 53, a determination is made whether a change in the current frame size (i.e. the number rows and columns of pixels) of the display data stream should occur. For example, in one embodiment, if the amount of data reduction to a target display data stream exceeds a specific threshold typically 30 to 50% (TH1 in FIG. 2), through the use of data compression alone, it is determined that further data reduction is to occur through the use of scaling (i.e. reduction of the number of rows and columns of pixels). However, if the amount of data reduction to a display data stream due to a current set of compression factors is less than the threshold, it is determined that scaling is to be unaffected. For example, in range 186 of FIG. 2, only compression is used. Note that when the threshold TH1 is exceeded, such as at range 187 of FIG. 2, the amount of scaling can be increased or decreased gradually to provide the needed data reduction. For example, referring to FIG. 2, as the amount of desired data reduction increases within range 187 so does the amount of scaling used. While, below threshold TH1, typically below 30% to 50% depending on system parameters, only compression (100%) is used. Above the threshold, no further compression is applied but scaling is used. It will be appreciated that changes in scaling need to occur at an I-Frame and will be applied to all frames associated with a group of pictures that begins with an I-Frame, while various compression techniques, such as quantization, can change on a frame-by-frame basis as bandwidth information becomes available.

Once it is determined that the level of scaling to be applied to a display data stream is to change, flow proceeds to block 58 where a scaling variable is provided to an encoder to set one or more scaling factors to be applied. For example, if the scaling level is to be increased to further increase the amount of data reduction, the number of pixels representing the height can be reduced, as can the number of pixels representing the width. Alternatively, when operating in range 187 the scaling level can be decreased when there is sufficient available bandwidth to support providing more data to represent the display data stream. It will be appreciated that in one embodiment the largest possible resolution is selected that will accommodate providing a display data stream that is capable of being transmitted at the available bandwidth within the threshold. Note that in one embodiment, range 187 of FIG. 2 represents scaling in the vertical direction, as discussed at state 140 of FIG. 3, that removes rows of pixels, while range 188 of FIG. 2 represents scaling in the horizontal direction, as discussed at state 150 of FIG. 3, that will remove columns of pixels. For example, when a total amount of desired data reduction exceeds threshold TH2, there will be three data reduction techniques used, as represented by lines 181-183, to achieve the desired amount of data reduction. Note that line 189 is the sum of lines 181-183, and represents a total amount of data reduction applied. It will be appreciated that data reduction techniques can also be used other than those discussed with reference to FIG. 2.

The current scaling and compression factors set at blocks 57 and 58 are used to encode the received display data stream target displays stream for transmission over an available bandwidth. In addition, the flow of FIG. 1 returns to block 51 to adapt the data reduction variables as necessary based upon changes in acceptability of the current bandwidth. Therefore, Subsequent iterations through the flow of FIG. 1 can result in subsequent portions of the display data stream being encoded and transmitted that represent frames of different pixel heights and widths, and different amounts of data compression than the current display data stream.

Referring now to FIG. 3, a state machine diagram of an Adaptive Bandwidth Footprint Matching (ABFM) method with three kinds of degradation is illustrated according to at least one embodiment of the present invention, where degradation is used to reduce amount of data and/or the data rate associated with a given data stream. Although the following discussion makes use of video streams for ease of illustration, other data formats, such as audio, display, analog, digital, multimedia, and the like, may be used in accordance with various embodiments. In steady state 100, each video stream of a plurality of video streams is operating within acceptable parameters. In at least one embodiment, a video stream is determined to be acceptably operating when the transmission of a frame of video data is transmitted without exceeding a maximum allowed delay time. For example, digital video streams such as MPEG often have time stamp information embedded within the stream. In addition to the start time T0 (when the frame was successfully transmitted) of the first frame in a sequence of frames with a fixed interframe time, this time stamp information, including the known interframe time (which is fixed for a sequence of frames), can be used to calculate the estimated times of each frame as they arrive. For example, in one embodiment, the estimated time of frame transmission completion T′j for frame N is calculated as T′j(N)=T0+N*D, where D is the interframe time. In this case, if the estimated times for transmission of the start of each frame of a stream j is within acceptable limits and has not exceed a maximum allowed delay Dj, stream j can be considered as operating within acceptable parameters. The acceptable parameters may be set by an administrator, determined empirically, and the like.

The desired tolerance Dj (or maximum acceptable delay time) can be calculated using a variety of methods. In one embodiment, the method used is to take into consideration the buffering size of each client receiver unit, and ensure that the client receiver unit will not run out of media content to decode. A typical formula to calculate Dj is to take the size of the buffer and estimate a lower bound (in units of time) to consume, or fill, the buffer. As it is often desirable to keep the buffer of each client receiver unit as full as possible, a typical Dj will be calculated as Dj=Tj(estimate)/2. Where Tj(estimate) is the estimated lower time bound to completely consume the input buffer of a receiver unit associated with stream j. Alternately, instead of using ½ of Tj(estimate), a more aggressive approach would be to use ¾ of Tj(estimate), and a more conservative approach might take ⅓ of Tj(estimate). In cases where Tj(estimate) is small for receiver devices that are incapable of providing considerable buffer space, a conservative approach may be more appropriate. In one embodiment, Tj(estimate) is obtained by taking observed peak (highest) data rate (in bytes/second) of stream j and the smallest size of the buffers (in bytes) of all the devices receiving stream j. In this case, Tj(estimate) can be evaluated as Bp/Rp, where Bp is the receive buffer size of device p and Rp is the peak data rate of stream j associated with device p, where device p receives stream j and has the smallest receive buffer. Alternately, Rp can be associated with any value between the mean (average) and the peak. In one embodiment, the peak data rate (Rp) can be based on the largest compressed frame. If the receiving client unit does not have enough buffering capability for at least one compressed frame then it is unlikely to be able to display the video smoothly without dropping frames.

At the commencement of each unit of media, such as a frame of video, the ABFM state machine transitions to state 110. In state 110, the actual transmit time Tj (the actual time of frame transmission completion) is compared against the estimated transmit time T′j (the expected time of frame transmission completion) at the start of each frame of stream j. In one embodiment, if the actual time of frame transmission completion exceeds the estimated time by less than the desired tolerance Dj (i.e. Tj−T′j<Dj), the ABFM state machine returns to steady state 100. Otherwise, if the actual transmit time exceeds the estimated time by at least desired tolerance Dj (i.e. Tj−T′j>=Dj), the ABFM state machine enters state 120. It will be appreciated when a video stream is being represented by a group of pictures, and not just I-frames, that the ABFM state machine would transition to state 110 at the commencement of each group of pictures.

In state 120, a victim stream v is selected from the plurality of video streams. In one embodiment, victim stream v is selected using a predetermined selection method, such as by round robin selection where each video stream is chosen in turn. In another embodiment, the victim stream v is selected based on a fixed priority scheme where lower priority streams are always selected before any higher priority scheme. In yet another embodiment, the victim stream v is selected based on a weighted priority scheme where the stream having the greatest amount of data and/or the priority of each stream plays a role in its probability of selection. It will be appreciated that when a single video stream is being transmitted, such as to a destination over a wireless connection, it will always be selected at state 120.

Regardless of the method of selecting a victim stream v, in one embodiment, each stream j has a count, herein referred to as A(j), that refers to the current degradation value of the modified stream of stream j. In this case, the current degradation value of victim stream v, A(v), is evaluated in state 120. If A(v) is 0, in one embodiment, the one or more quantization factors of the re-encoding process for the victim stream v are changed in state 130, thus resulting in a decreased in the amount of data transmitted in victim stream v when greater reduction in transmitted data is needed. In one embodiment, escalation of the degree of data compression occurs when the quantization factors are increased resulting in a decrease in the amount of data transmitted in victim stream v. For example, the MPEG algorithm uses quantization factors to reduce the amount of data by reducing the precision of the transmitted video stream. MPEG relies on quantization of matrices of picture elements (pixels) or differences in values of pixels to obtain as many zero elements as possible. The higher the quantization factors, the more zero elements produced. Using algorithms such as run-length encoding, video streams (or their associated matrices) containing more zeros can be more highly compressed than video streams having fewer zeros.

For example, the MPEG algorithm for compression of a video stream has a stage in the algorithm for a discrete cosine transform (DCT), a special type of a Fourier Transform. The DCT is used to transform blocks of pixels in the time domain to the frequency domain. As a result of this transformation, the elements in the frequency domain, post-DCT, that are closest to the top left element of the resulting matrix with indices (0,0) are weighted more heavily compared to elements at the bottom right of the matrix. If the matrix in the frequency domain were to use less precision to represent the elements in the lower right half of the matrix of elements, the smaller values in the lower right half will get converted to zero if they are below a threshold based on a quantization factor. Dividing each element by a quantization factor is one method utilized to produce more zero elements. MPEG and related algorithms often apply larger quantization values to decrease the precision of the matrices in the frequency domain, resulting in more zero elements, and hence a decrease the data transmission rate. It will be appreciated that while state 130 specifically discusses compression using quantization, other types of compression can be used, such as changing the pixel depth of each pixel.

After reducing the data transmission of the victim stream v by modifying the quantization factor (state 130), in one embodiment, the ABFM state machine transitions to state 160, where the degradation value A(v) is increased by one and then a modulus of 3 is applied, i.e. A(v)current=(A(v)previous+1) mod 3. As a result, the value of A(v) can cycle from 0 to 2 for a given stream. Since A(v) was previously determined to be 1 in state 120, the new A(v) value would be 1 (0+1 mod 3). After modifying the degradation value A(v) for victim stream v in state 160, the ABFM state machine transitions back to state 100. Note that the degradation value 160 is incremented when it is desirable for further data reduction of the current display data stream to use the scaling technique of state 140, as opposed to the compression technique of state 130. Therefore, the degradation value can remains unchanged at state 160 if it is desirable for additional data reduction through the use of the compression of the display data stream using the compression technique of state 130. For example, referring to table 2, when the amount of desired data reduction is less than 30% to 50% depending on system parameters, the degradation value A(v) remains zero for the selected stream to indicate further data reduction can occur by modifying the compression variables. When at or near 30% to 50% threshold of data reduction, the degradation value A(v) is incremented to facilitate further data reduction by modifying scaling variables at state 140 while maintaining the compression variables. When at or near 30% to 50% data reduction threshold, the degradation value A(v) can be incremented to facilitate further data reduction to occur by modifying scaling variables at state 150 while maintaining the previously set compression and scaling variables.

If A(v) is determined to be 1 for victim stream v in state 120, the ABFM state machine enters state 140. In one embodiment, the height of the reencoded data stream is reduced by a predetermined amount, ½ for example, in state 140, resulting in a decreased amount of data to be transmitted. One method used to scale blocks of pixels by half is to blend and average pixels. Another method used is to drop every other pixel. In cases where the video stream is interlaced, halving the height can be achieved by dropping alternate fields, such as dropping all of the odd horizontal display rows or all of the even horizontal display rows. It will be appreciated that in some formats, particularly those in the National Television System Committee (NTSC) and the Advanced Television System Committee (ATSC) formats, video streams are interlaced where the even horizontal display rows for an entire frame are displayed first and then the odd horizontal display rows are displayed next. In other embodiments, the height of the reencoded data stream is reduced by a factor other than a half, such as ⅓, using similar methods as appropriate. Note that the amount of compression, as previously set by state 130, can be changed or remain the same during state 140. For example, if the degradation value A(v) is set to one once the data compression of the target stream is 40%, it would be possible for state 140 to eliminate data compression and remove every other line of pixels of the target data stream to incrementally reduce the amount of data representing the target stream from 40%, using just compression, to 50% using just scaling. Alternatively, all or some data compression can be maintained while performing less scaling to achieve a 50%, for example, total data reduction.

After reducing the data transmission of the victim stream v by reducing the resolution of the stream (state 140), in one embodiment, the degradation value A(v) is modified in state 160, as discussed previously. The resulting value for A(v) is 2 (1+1 mod 3). After modifying the degradation value A(v) for victim stream v in state 160, the ABFM state machine transitions back to state 100. Note that the degradation value 160 is incremented when it is desirable for further data reduction of the current display data stream to use the scaling technique of state 150, as opposed to the scaling technique of state 140. Therefore, the degradation value remains unchanged at state 160 if it is desirable for additional data reduction through the use of the compression of the display data stream using the compression technique of state 130.

If A(v) is determined to be 2 for victim stream v in state 120, the ABFM state machine enters state 150. In one embodiment, the width of the reencoded data stream is reduced by a predetermined amount in state 150 using methods similar to those discussed previously with reference to state 140, such as dropping every other pixel. It will be appreciated that for a same reduction factor, the reduction methods of state 140 or state 150 are interchangeable. In cases where the victim stream v is interlaced, halving the height before the width is generally more appropriate as it is more efficient to completely skip alternating fields, saving substantial processing requirements. As discussed previously, the previously applied compression and scaling previously set at states 130 and 140 can be maintained or changed at state 150.

After the reducing the data transmission of the victim stream v by reducing the resolution of the stream (state 150), in one embodiment, the degradation value A(v) is modified in state 160, as discussed previously. The resulting value for A(v) is 0 (2+1 mod 3). After modifying the degradation value A(v) for victim stream v in state 160, the ABFM state machine transitions back to state 100. As discussed previously, the previously applied compression and scaling previously set at states 130 and 140 can be maintained or changed at state 150.

In one embodiment, as a result of the cycling between 0 to 2 of the degradation value A(v) for a victim stream v, the ABFM state machine cycles through three different kinds of degradation of the resolution and/or the precision of victim stream v each time it is selected for degradation in state 120. Although an ABFM state machine utilizing three kinds of data degradation has been discussed, in other embodiments, fewer or more steps of data degradation may be used according to the present invention. For example, in one embodiment, an ABFM state machine utilizes multiple step degradation involving more than one state of changing of quantization factors. It will also be appreciated that scaling factors of width and height other than ½ (e.g.: ¾) may be used. For example, in one embodiment, the amount by which the resolution and/or precision of a victim stream v is based on the degree to which the actual frame transmission completion time for a frame of video in victim stream v exceeds the estimated frame transmission completion time. For example, if the actual frame transmission completion time is 10% greater than the estimated frame transmission completion time, then the resolution of victim stream v could be scaled down by 10%, thereby causing the actual frame transmission completion time to likely come closer to the estimated frame transmission completion time.

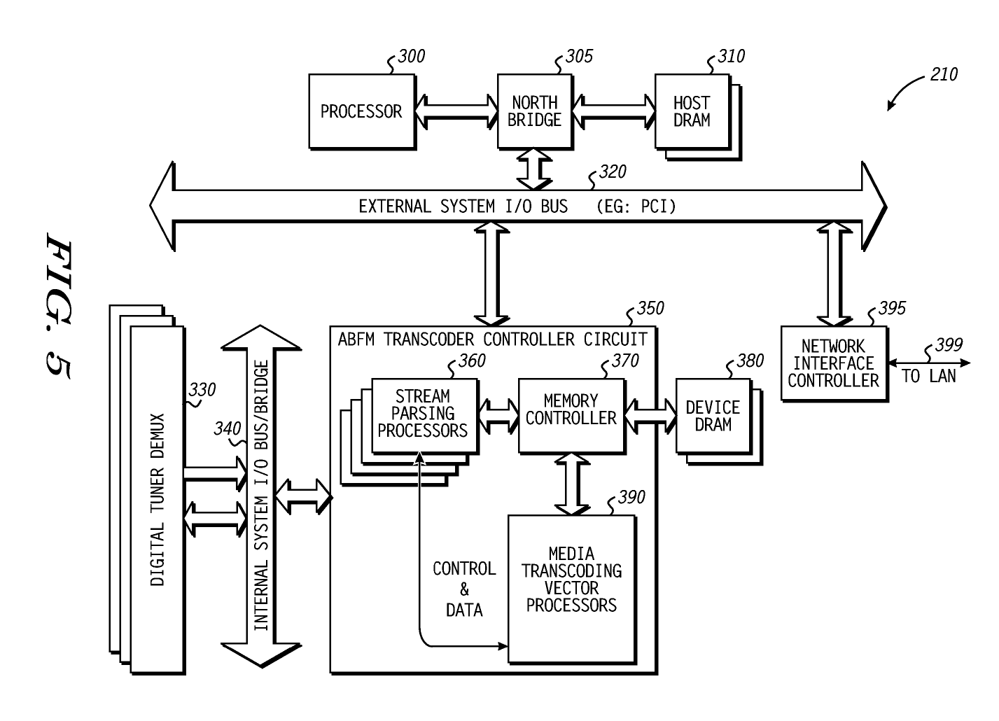

Referring next to FIG. 4, Adaptive Bandwidth Footprint Matching (ABFM) server system 205 is illustrated according to at least one embodiment of the present invention. Data streams, such as video data, display data, graphics data, MPEG data, and the like, are input to gateway media server 210. In one embodiment, two main input sources are used by gateway media server 210. One input is wide area network (WAN) connection 200 to provide high speed Internet access. The other input is a source of media streams, such as satellite television (using satellite dish 201) or cable television. In other embodiments, other input sources can be used, such as a local area network (LAN). WAN connection 200 and/or other used input sources which can include a network comprised of cable, twisted pair wires, fiber optic cable, a wireless radio frequency net work, and the like.

Gateway media server 210, in one embodiment, accepts one or more input data streams, such as digital video or display data, from satellite dish 201 and/or WAN 200. Each input data stream can include a plurality of multiplexed channels, such as MPEG data channels. Gateway media server 210 broadcasts the data streams and/or channels over a common medium (local data network 220) to one or more receiving client units, such as laptop 230, computer 240, or viewing unit 250. In one embodiment, there is a one-to-one correspondence between the number of data channels input to gateway media server 210 and the number of client receiver units to receive output data channels or streams. In another embodiment, there are fewer data channels or streams than there are receiver client units. In this case, two or more client receiver units may need to share one or more data channels or streams. Local data network 220 can include a local area network, a wide area network, a bus, a serial connection, and the like. Local data network 220 may be constructed using cable, twisted pair wire, fiber optic cable, etc. During broadcast of the data streams to the receiving client units, gateway media server 210, in one embodiment, applies the ABFM algorithm, as discussed previously with reference to FIG. 1, to manage the network traffic to assure consistent and sustained delivery within acceptable parameters, thereby allowing users to view the data stream seamlessly.

In at least one embodiment, the ABFM algorithm is utilized by gateway media server 210 to attempt to ensure that a representation of the display data meets a predetermined criteria. For example, gateway media server 210 may transmit the display data to receiver client units, where a video sequence displayed on the receiver client units is a representation of the displayed data. If the video sequence is simultaneously displayed properly in real time (the predetermined criteria) on a number receiver client units, gateway media server 210 may not need to take further action. Else if the video sequence is choppy, is not synchronized, is delayed, or is not received by all the designated receiver client units, the representation of the display data does not meet the predetermined criteria, and gateway media server 210, in one embodiment, uses the ABFM method previously discussed to modify one or more of the data streams of display data to improve the display of the video sequence.

As discussed previously, in at least one embodiment, an ABFM algorithm is implemented to maintain the data transmission rate of ABFM server system 205 within a fixed bandwidth. In one embodiment, the bandwidth of ABFM server system 205 is fixed by the maximum bandwidth of the transmission medium (local data network 225) between gateway media server 210 and the client receiver units (laptop 230, computer 240, or viewing unit 250). For example, if local data network is a local area network having a maximum transmission rate of 1 megabit per second, the bandwidth of ABFM server system 205 may be fixed at a maximum of 1 megabit per second. Alternately, in another embodiment, the bandwidth of ABFM server system 205 could be a predetermined portion of the available bandwidth of the transmission medium (local data network 225). For example, if there are four ABFM server systems 205 connected to local data network 225 having a maximum transmission rate of 1 megabit per second, each ABFM server systems 205 could be predetermined to have a fixed bandwidth of 0.25 megabits per second (one fourth of the maximum available transmission rate). As previously discussed, the AFBM algorithm can also be implement to maintain the data transmission rate within a varying bandwidth, such as is common with wireless communication channels.

Although the transmission medium between gateway media server 210 and client receiver units is often the factor which limits or fixes the bandwidth of ABFM server system 205, in one embodiment, the bandwidth of ABFM server system 205 is fixed by the rate at which gateway media server 205 is able to input one or more data streams, compress one or more of the data streams, and output the compressed (and uncompressed) data streams or channels to the client receiver units. For example, if gateway media server 205 can only process 1 megabits of data per second, but local data network 225 has a transmission rate of 10 megabits per second, the bandwidth of ABFM server system 205 may be limited to only 1 megabits per second, even though local data network 225 can transmit at a higher transmission rate. It will be appreciated that the bandwidth of ABFM server system 205 could be limited by other factors without departing from the spirit or the scope of the present invention.

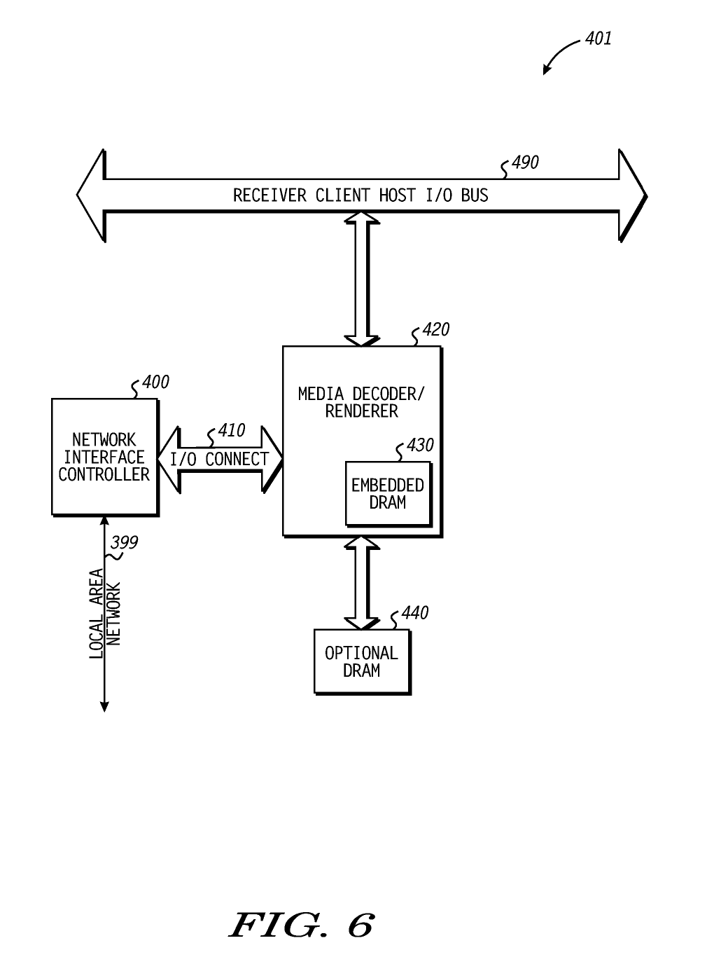

Referring to FIG. 5, gateway media server 210 is illustrated in greater detail according to at least one embodiment of the present invention. Input media streams enter the system via digital tuner demultiplexors (DEMUX) 330, from which the appropriate streams are sent to ABFM transcoder controller circuit 350. ABFM transcoder controller circuit 350, in one embodiment, includes one or more stream parsing processors 360 that perform the higher level tasks of digital media decoding, such as video decoding. Stream parsing processors 360 drive a series of media transcoding vector processors 390 that perform the low level media transcoding tasks. The intermediate and final results of the decoding and transcoding are stored in the device memory, such as dynamic random access memory (DRAM) 380. The final compressed transcoded data, in one embodiment, is transmitted according to a direct memory access (DMA) method via external system input/output (IO) bus 320 past north bridge 305 into the host memory (host DRAM 310). Processor 300, using a timer driven dispatcher, at an appropriate time, will route the final compressed transcoded data stored in host DRAM 310 to network interface controller 395, which then routes the data to local area network (LAN) 399.

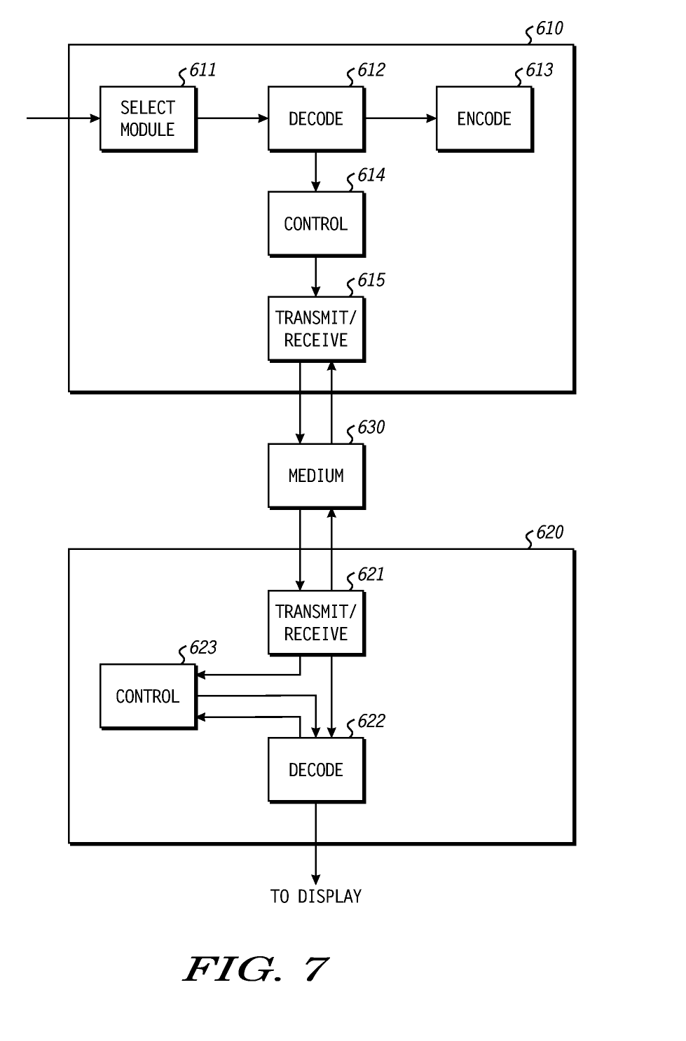

Referring next to FIG. 6, receiver client unit 401 is illustrated according to at least one embodiment of the present invention. Receiver client unit 401 can include devices capable of receiving and/or displaying media streams, such laptop 230, computer 240, and viewing unit 250 (FIG. 4). The final compressed transcoded data stream as discussed with reference to FIG. 5 is transmitted to network interface controller 400 via LAN 399. The data stream is then sent to media decoder/renderer 420 via IO connect 410. IO connect 410 can include any IO connection method, such as a bus or a serial connection. Media decoder/renderer 420, in one embodiment, includes embedded DRAM 430 which can be used as an intermediate storage area to store the decoded data. In cases where the decoded data does not fit within embedded DRAM 430, media decoder/renderer 420 further includes DRAM 440, which is larger than embedded DRAM 430. As the compressed data is decoded, it is transmitted to receiver client IO bus 490 and eventually is picked up by the receiver client unit's host processor (not shown). In one embodiment, the host processor controls video decoder/renderer 420 directly and actively reads the rendered data. In other embodiments, the functions of video decoder/renderer 420 are performed on the host via a software application. In cases where the host processor is incapable of such decoding tasks, video decoder/renderer 420 performs part of or all of the decoding tasks.

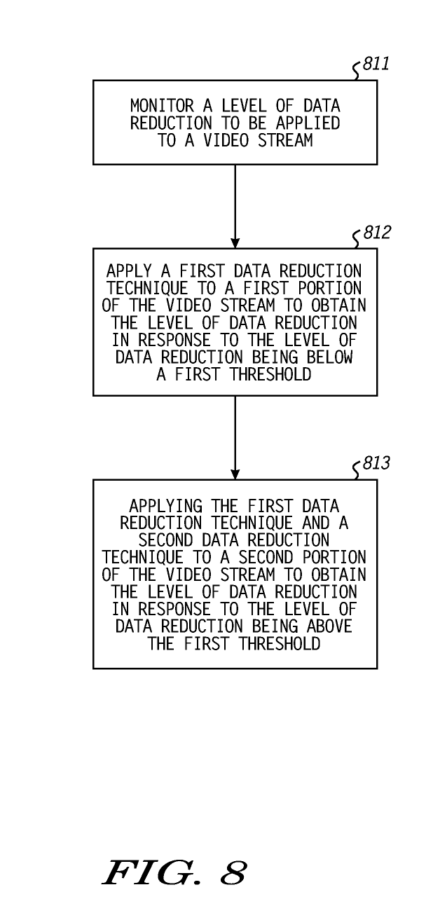

FIG. 7 illustrates a specific implementation of a system having a server 610, such as that described at FIG. 5, and a client, such as the one described at FIG. 6. In operation, one or more display streams are received at the select module 61, which selects and provides one display stream to decode module 612.

Decode module 612 will decode the selected display stream (target stream) and provide relevant control information, such as the resolution and compression variables associated with the displays stream, if any, to control module 614. Control module 614 also receives information from a transmit/receive module, such as a wireless transmission module, as to the available bandwidth over transmission medium 630, information from encode module 613 relating to the amount of data associated with display data as it is currently being encoded, and information from the client 620 indicating its ability to process information. Based upon this information, the control module 614 can modify compression variables used by the encode module 613 on a frame-by frame basis, and to modify scaling variables used by a scalar of the encode module 613 to change the amount of data used to represent the selected display stream to continually provide the highest quality video possible while maintaining a high degree of confidence that the video can be successfully transmitted within the available bandwidth.

The client 620 will receive information transmitted over transmission medium 630 at transmit receive module 621. The received display data stream will be provided to the decode module 622, while control information such as compression and resolution information will be provided to the control module 623, which in turn will configure decode module 622. Status information relating to decoding of the display data can be provided from the module 622 to the control module 623. For example, buffer fullness information can be provided from the decoder to the control module 623 to control the rate at which information is received at the transmit/receive module 621. In addition, control module can provide feed back information to the server 610 about its video requirements. For example, information relating the resolution and supported video formats can be communicated from the control module 623 to the server 610 through the transmit/receive module 621.

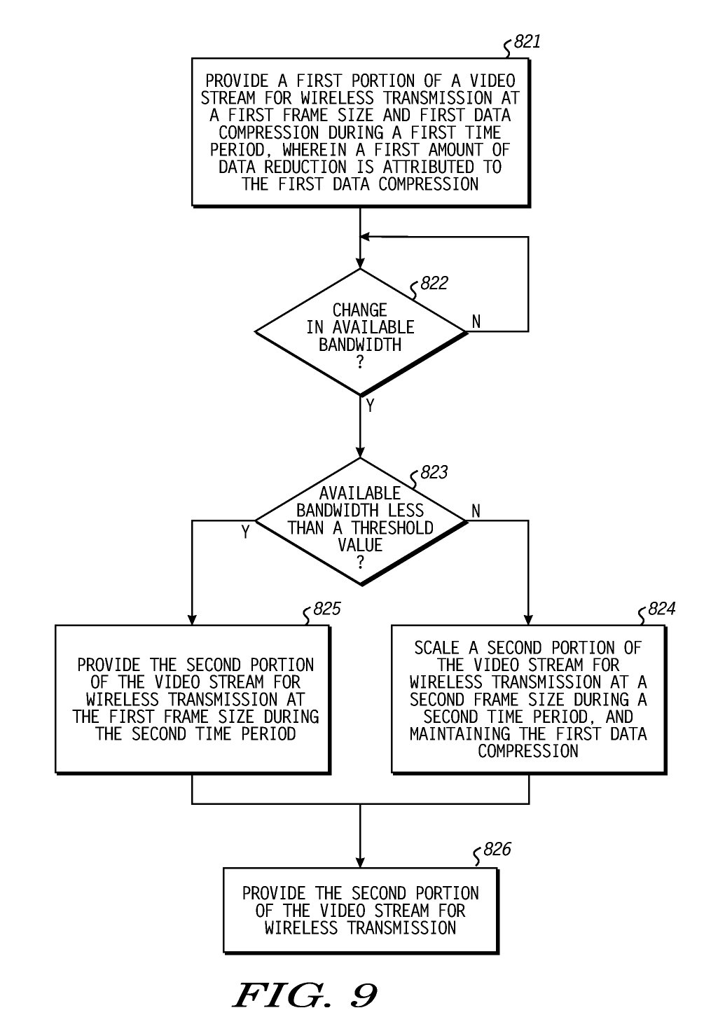

FIG.8 illustrates a method in accordance with a specific embodiment of the present disclosure. At block 811, a level of data reduction to be applied to a video stream is monitored. For example, as previously discussed, if a bandwidth available to transmit a data stream falls below an acceptable level, or the amount of data needed to be transmitted over an available bandwidth increases, it is possible that data associated with a data stream can be lost. At block 812, a first data reduction technique is applied to a first portion of a video stream to obtain the level of data reduction desired in response to a desired level of data reduction being below a first threshold. For example, referring to FIG. 2, when a total desired data reduction is below the threshold TH1, for example below 30-50%, the first data reduction technique will be applied. The first data reduction technique can be a compression technique, such as quantization, or a scaling technique as previously discussed. At block 813, the first data reduction technique and a second data reduction technique are applied to a second portion of the video stream to obtain the level data reduction in response to the level of data reduction being above the first threshold. For example, referring back to FIG. 2, when the total desired data reduction is above the threshold TH1, and below the threshold TH2, both a data compression technique, as represented by line 181, and a second data reduction technique, such as scaling as represented by line 182, can be used to reduce the frame size. It will appreciated that other data reduction techniques, such as compression by changing the color-depth available, can be used in accordance with the method of FIG. 8.

FIG. 9 illustrates a flow diagram of a method in accordance with a specific embodiment of the present disclosure. At block 821, a first portion of a video stream having a data compression and first frame size is provided during a first time period for wireless transmission, wherein a first amount of data reduction is attributed to the first data compression. Referring to FIG. 2, the frame size of a portion of video stream to be transmitted wirelessly is held constant when the total desired data reduction is below the threshold value TH1. As represented by curve 181, only the amount of compression applied to a video frame is changed for desired data reduction amounts less than TH1. For total desired data reduction amounts greater than TH1, a constant amount of compression is maintained, and other data reduction techniques are used to reduce the amount of data transmitted.

At block 882, a determination is made whether or not a change in available bandwidth has occurred. If not, the flow returns to block 822 until a change is detected. The flow proceeds to block 823 when a change is detected. In accordance with a specific embodiment of the present disclosure, a change in available bandwidth is determined by obtaining a current available bandwidth from a transmission module and comparing this value to previous values. Once a change in bandwidth is detected, it can be further determined whether the first portion of the video stream can be transmitted at the current available bandwidth. Determining the change in available bandwidth can be accomplished by determining if the first portion of the video stream can be transmitted at the current available bandwidth. At block 823, a determination is made whether or not the available bandwidth is less than a threshold value. If so, flow proceeds to block 825, otherwise the flow proceeds to block 824. At block 824, a second portion of the video stream is scaled for wireless transmission at a second frame size during a second time period in response to determining that the bandwidth is greater than the threshold value. In accordance with a specific embodiment of the present disclosure, the second frame size can be selected to be the largest frame size suitable for transmission at the available bandwidth. During the second time period, the first data compression is maintained.

At block 825, if the response to determining the available bandwidth is less than a threshold value, a second portion of the video stream is provided for video transmission at the first frame size during the second time period. Referring to FIG. 2, this corresponds to values with total desired data reduction less than the threshold TH1. During this time, the frame size is held constant and a compression technique is varied.

At block 826, the video stream is wirelessly transmitted.

One implementation of the invention is as sets of computer readable instructions resident in the random access memory of one or more processing systems configured generally as described in FIGS. 1-6. Until required by the processing system, the set of instructions may be stored in another computer readable memory, for example, in a hard disk drive or in a removable memory such as an optical disk for eventual use in a CD drive or DVD drive or a floppy disk for eventual use in a floppy disk drive. Further, the set of instructions can be stored in the memory of another image processing system and transmitted over a local area network or a wide area network, such as the Internet, where the transmitted signal could be a signal propagated through a medium such as an ISDN line, or the signal may be propagated through an air medium and received by a local satellite to be transferred to the processing system. Such a signal may be a composite signal comprising a carrier signal, and contained within the carrier signal is the desired information containing at least one computer program instruction implementing the invention, and may be downloaded as such when desired by the user. One skilled in the art would appreciate that the physical storage and/or transfer of the sets of instructions physically changes the medium upon which it is stored electrically, magnetically, or chemically so that the medium carries computer readable information.

In the preceding detailed description of the figures, reference has been made to the accompanying drawings which form a part thereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical, chemical and electrical changes may be made without departing from the spirit or scope of the invention. To avoid detail not necessary to enable those skilled in the art to practice the invention, the description may omit certain information known to those skilled in the art. Furthermore, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention. The preceding detailed description is, therefore, not to be taken in a limiting sense, and the scope of the present invention is defined only by the appended claims.

What is claimed is:

1. A method comprising:
monitoring a level of data reduction to be applied to a video stream;
applying a first data reduction technique to a first portion of the video stream to obtain the level of data reduction in response to the level of data reduction being below a first threshold; and
applying the first data reduction technique and a second data reduction technique to a second portion of the video stream to obtain the level of data reduction in response to the level of data reduction being above the first threshold.

2. The method of claim 1 wherein applying the first data reduction technique further includes applying the first data reduction technique to achieve data reduction of the video stream corresponding to data reduction up to the first threshold and applying the second data reduction technique to achieve data reduction of the video stream corresponding to data reduction above the first threshold.

3. The method of claim 2 wherein the first data reduction technique is a compression technique.

4. The method of claim 3 wherein the compression technique is quantization.

5. The method of claim 4 wherein the compression technique reduces color depth.

6. The method of claim 3 wherein the second data reduction technique is a scaling technique to reduce frame size.

7. The method of claim 6 wherein the compression technique is quantization.

8. A method comprising:
providing a first portion of a video stream for wireless transmission at a first frame size and first data compression during a first time period, wherein a first amount of data reduction is attributed to the first data compression;
determining a change in available bandwidth has occurred in a wireless communications channel; and
in response to determining the change in available bandwidth has occurred, scaling a second portion of the video stream for wireless transmission at a second frame size during a second time period, wherein the first frame size is different than the second frame size, and maintaining the first data compression.

9. The method of claim 8 wherein the second frame size is less than the first frame size.

10. The method of claim 8 wherein the first frame size is less than the second frame size.

11. The method of claim 8 further comprising, in response to determining the change in available bandwidth has occurred,
providing the second portion of the video stream for wireless transmission at the second frame size during the second time period in response to the change in available bandwidth resulting in the available bandwidth being less than a threshold value; and
providing the second portion of the video stream for wireless transmission at the first frame size during the second time period in response to the change in available bandwidth resulting in the available bandwidth being greater than the threshold value.

12. The method of claim 8 further comprising, in response to determining the change in available bandwidth has occurred, determining the second frame size based on the available bandwidth.

13. The method of claim 12 wherein determining the second frame size based on the available bandwidth includes the second frame size being a largest frame size capable of being transmitted at the available bandwidth.

14. The method of claim 12 wherein the first data compression is based on quantization.

15. The method of claim 8 wherein determining the change in available bandwidth further includes obtaining a current available bandwidth from a transmission module.

16. The method of claim 15 wherein determining the change in available bandwidth further includes determining if the first portion of the video stream can be transmitted at the current available bandwidth.

17. The method of claim 15 wherein determining the change in available bandwidth further includes comparing the current available bandwidth to a previous available bandwidth.

18. The method of claim 8 wherein determining the change in available bandwidth further includes receiving an indicator from a transmission module.

19. The method of claim 18 wherein receiving the indicator from a transmission module occurs at an indeterminate time.

20. The method of claim 8 wherein the wireless transmission is a transmission compliant with 802.11.

21. A system comprising:
a wireless transmission module comprising an input, and an output to provide bandwidth information for a wireless connection;
a control module comprising an input coupled to the output of the wireless transmission module and an output to provide frame size information of an image to be transmitted; and
a compression module comprising an input coupled to the output of the control module, and an output coupled to the input of the wireless transmission module to provide a video image having a frame size based on the frame size information.
